(19) United States
(12) Patent Application Publication
(10) Pub. No.: US 2014/0260726 A1
(43) Pub. Date: Sep. 18, 2014

(54) MULTI-PURPOSE ACTUATOR

(71) Applicant: Cummins IP, Inc., (US)

(72) Inventors: Siamak Atar, Newtown, PA (US); Onkarappa Bolanahalli, Columbus, IN (US); Rohini Ulhas Deutkar, Pune (IN); Marc A. Greca, Bargersville, IN (US); J. Victor Perr, Greenwood, IN (US)

(73) Assignee: CUMMINS IP, INC., Columbus, IN (US)

(21) Appl. No.: 13/838,680

(22) Filed: Mar. 15, 2013

(51) Int. Cl. F16H 1/14

(52) U.S. Cl. CPC F16H 1/14
USPC 74/89.16

(57) ABSTRACT

An actuator assembly includes a housing that includes an input interface and an output interface. The assembly further includes a torque generating device coupled to an input shaft. The torque generating device is coupled to the input interface of the housing such that the input shaft is positioned within the housing. The assembly also includes a spur gear that is coupled to the input shaft and a face gear that is positioned within the housing. The face gear is in gear meshing engagement with the spur gear. Additionally, the assembly includes an output shaft that is coupled to the face gear and extends from the output interface. The output shaft is approximately perpendicular to the input shaft.

### FIELD

The present disclosure relates generally to an actuator, and more particularly to an automotive actuator with an input shaft perpendicular to an output shaft.

### BACKGROUND

Actuators in electro-mechanical systems are well known in the art. Generally, an actuator is designed to control a specific mechanism or system by providing an actuated output based on an input. The input may be a source of energy, usually in the form of an electric current, hydraulic fluid pressure, or pneumatic pressure. The actuator converts the input energy into any of various types of motion. Actuators can affect the operation of a system based on either pre-determined design criteria or external manipulation (e.g., user input).

In conventional electro-mechanical systems, actuators are frequently used to initiate or terminate motion. Some typical actuators include an electric, hydraulic, or pneumatic motor that is mechanically coupled to motion-transmitting components, such as an assembly of gears or screws. For example, engagement elements (e.g., cogs) of a first component driven by the motor engage the engagement elements of a second component to transmit motion from the motor to the second component via the first component. Often, the speed and type of motion of the second component is different than the electric motor by virtue of a non-unity component ratio and/or difference in component type. Generally, many different actuator configurations are available to convert the rotational motion of an output shaft of a motor to different speed or different type of motion (e.g., linear).

Some actuators are designed for high speed, high force, or a compromise between high speed and force. There may be many different factors or constraints, such as range-of-motion, speed, force, accuracy, and installation space, that drive the selection of a particular type of actuator (e.g., types of gear linkages, types of lead screw mechanisms, and associated ratios) to meet the requirements of a particular application. Recently, the demand for specialized actuators, such as actuators for controlling the flow of air or exhaust for engine applications, has increased. For example, as systems get more complex, become more electronically integrated, and require smaller footprints, the demand for specialized actuators correspondingly increases. Furthermore, current actuators are limited in their application and ability to accept varying interfaces commonly associated with more complex systems and electronically integrated systems.

### SUMMARY

The subject matter of the present application has been developed in response to the present state of the art, and in particular, in response to the problems and needs associated with actuators, such as those actuators used to control the flow of air or exhaust gas for engine applications. For example, as discovered by the inventor of the present application, the current state of the art has shortfalls and limitations. The majority of current actuators in the art use rack and pinion mechanisms that require a significant amount of package space to meet travel requirements. Other actuators use lead screw or worm gear arrangements that typically have concerns with response time due to high reduction ratios. In addition, neither is adequately backdriveable, or has the ability to be driven from the output shaft, which can be a desired function.

According to one embodiment described herein, an actuator assembly includes an input drive shaft that is perpendicular to an output shaft. This is accomplished with the use of a spur gear coupled to the input shaft and a face gear meshed with the spur gear. The face gear is meshed with the output shaft. Further, the actuator assembly includes a housing that enables mounting of modular input and output devices at 90-degree intervals about the input and output interfaces of the housing, respectively.

In yet another embodiment, an actuator assembly includes a housing that includes an input interface and an output interface. The assembly further includes a torque generating device coupled to an input shaft. The torque generating device is coupled to the input interface of the housing such that the input shaft is positioned within the housing. The assembly also includes a spur gear that is coupled to the input shaft and a face gear that is positioned within the housing. The face gear is in gear meshing engagement with the spur gear. Additionally, the assembly includes an output shaft that is coupled to the face gear and extends from the output interface. The output shaft is approximately perpendicular to the input shaft.

In some implementations, the torque generating device rotationally drives the input shaft and spur gear. The torque generating device can be selected from the group consisting of an electromagnetic motor and pneumatic drive. In certain implementations, the assembly includes an output device coupled to the output interface. The output device is rotationally coupled to the output shaft. The output interface can include a pilot feature. In some instances, the output interface includes four mounting apertures that are circumferentially spaced about the output shaft an equal distance apart from each other.

According to some implementations, the gear meshing engagement between the face gear and spur gear allows backdrivability of the input shaft by the output shaft. The actuator assembly may include a printed circuit board (PCB) mounted within the housing and electrically coupled to the torque generating device. The PCB can be configured to electrically control actuation of the torque generating device. The PCB can be electrically coupled to the torque generating device via a universal connector forming an integral part of the housing.

In certain implementations, a torque multiplication ratio between the input and output shafts is at most about 50:1. The torque generating device generates at most about 15 Newton meters (N-m) in some instances.

According to another embodiment, an internal combustion engine includes an actuator assembly that has a housing with an input interface and an output interface. The engine includes a torque generating device coupled to an input shaft. The torque generating device is coupled to the input interface of the housing such that the input shaft is positioned within the housing. The engine also includes a spur gear coupled to the input shaft and a face gear positioned within the housing. The face gear is in gear meshing engagement with the spur gear. Additionally, the engine includes an output shaft that is coupled to the face gear and extends from the output interface. The output shaft is approximately perpendicular to the input shaft. The engine has an actuatable device mounted to the output interface and coupled to the output shaft.

In some implementations of the engine, the actuator assembly further includes a PCB mounted to the housing. The PCB is configured to electrically control actuation of the torque generating device. The actuator assembly may have four mounting apertures circumferentially spaced about the output shaft an equal distance apart from each other. The gear meshing engagement between the face gear and spur gear may allow backdrivability of the input shaft by the output shaft.

According to yet another embodiment, an actuator includes a housing and a spur gear positioned within the housing. The spur gear is rotatable about a first rotational axis. The actuator also includes an input shaft coupled with the spur gear. Additionally, the actuator includes a face gear that is positioned within the housing in gear meshing engagement with the spur gear. The face gear is rotatable about a second rotational axis that is perpendicular to the first rotational axis. Further, the actuator includes an output shaft coupled with the face gear.

In some implementations, the actuator includes a PCB and a universal connector mounted to the housing. The PCB is electrically coupled with the universal connector. The PCB is configured to electronically control actuation of the spur gear about the first rotational axis. Gear meshing engagement between the face gear and spur gear allows backdrivability of the spur gear by the face gear. The housing of the actuator may include a pilot feature about the output shaft. The pilot feature can be mateable with an accessory positioned between the housing and a device driven by the output shaft. The actuator housing includes a plurality of mounting apertures circumferentially spaced about the pilot feature. The mounting apertures are mateable with corresponding mounting features of the device driven by the output shaft.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 is a frontal isometric view of a multi-purpose actuator assembly in accordance with one embodiment of the present disclosure;

FIG. 2 is a rear isometric view of a multi-purpose actuator assembly in accordance with one embodiment of the present disclosure;

FIG. 3 is a frontal isometric view of a multi-purpose actuator assembly shown with a portion of a housing removed for convenience in showing a torque transmission device within the housing; and

FIG. 4 is a cross-sectional side view of a multi-purpose actuator assembly according to one embodiment of the present disclosure.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

Furthermore, the described features, structures, or characteristics of the subject matter described herein may be combined in any suitable manner in one or more embodiments. One skilled in the relevant art will recognize, however, that the subject matter may be practiced without one or more of the specific details, or with other methods, components, materials, and so forth. In other instances, well-known structures, materials, or operations are not shown or described in detail to avoid obscuring aspects of the disclosed subject matter.

Referring to FIGS. 1, 2, and 4, an actuator assembly 10 according to one embodiment includes an actuator housing 20 and a torque generating device 30 coupled to the housing. The housing 20 includes an input interface 22 and an output interface 24.

The input interface 22 is configured to receive the torque generating device 30. The torque generating device 30 can be any of various devices configured to generate torque. Generally, the torque generating device 30 converts one form of power into rotational power or torque. The torque generating device 30 can be any of various devices, such as an electromagnetic motor and pneumatic drive. In one embodiment, the input interface 22 includes engagement elements, such as threaded apertures, configured to receive corresponding engagement elements of the torque generating device 30, such as fasteners that extend through apertures in the torque generating device 30. The fasteners can be tightened within the threaded apertures of the input interface 22 to secure the torque generating device 30 to the housing 20. In the illustrated embodiment, a device cover 32 is positioned over the torque generating device 30 with the cover being affixed to the housing via a plurality of fasteners 34 that threadably engage corresponding threaded holes in the input interface 22 of the housing 20. The cover 32 can be used in conjunction with separate fasteners extending directly through the torque generating device into the housing. However, to accommodate torque generating devices without matching apertures or different interfaces, the cover 32 can be used to ensure the torque generating device is secured to the housing 20.

The output interface 24 is configured to receive a driven device 40 (shown schematically in FIG. 4). Referring to FIG. 1, the output interface 24 includes four tabs 26 positioned about an output shaft 50 of the assembly 10. In the illustrated embodiment, the tabs 26 are located an equidistance apart from each other (e.g., 90-degrees apart from each other). Each tab 26 includes a respective aperture 28. Each aperture 28 is configured to receive a respective fastener (not shown). The fasteners may extend through corresponding apertures in the driven device 40 and may be tightened against the tabs to secure the driven device to the output interface 24. The use of a plurality of apertures 28 facilitates a plurality of mounting orientations of the actuator assembly 10 relative to the driven device 40, or vice versa. In certain applications, such as those associated with tight spaces and specific spatial tolerances, mounting the actuator assembly 10 at a desired angle relative to the driven device 40 to accommodate special constraints may be desirable. Accordingly, the actuator assembly 10 can be mounted to the driven device 40 at one of four orientations spaced 90-degrees apart from each other. In some implementations, more than four apertures 28 may be used to provide even more flexibility in the possible mounting orientations of the actuator assembly 10 relative to the driven device.

The driven device 40 can be any of various components or sub-components of any of various systems. For example, the driven device 40 can be a component of an exhaust or air handling system, such as a turbocharger (e.g., VGT vane actuator), an exhaust gas recirculation (EGR) valve, exhaust throttle or break, and the like. In some implementations, it may be desirable to position a secondary component 44 between the driven device 40 and the output interface 24. However, aligning and mounting such a secondary component 44 to the housing 20 may be difficult. Accordingly, the output interface 24 includes a pilot feature 42 configured to receive and align a secondary component 44 prior to the driven device 40 being secured to the output interface. The pilot feature 42 is a generally circular protrusion extending axially away from the tabs 28. The protrusion of the pilot feature 42 can be received in a corresponding circular receptacle of the secondary component 44. Because the pilot feature 42 is circular, the secondary component 44 can be oriented in any of an infinite number of orientations as desired. The output shaft 50 is long enough that it extends axially beyond the end of the pilot feature 42 such that the driven device 40 may still receive and be driven by the output shaft 50 even with a secondary component positioned on and about the pilot feature 42 (see, e.g., FIGS. 1 and 4). The secondary device 44 can be any of various devices known in the art, such as a cooling jacket and the like.

The housing 20 includes a body 46 that defines an interior cavity 48 of the housing. The body 46 houses a torque transmission device 60. The torque transmission device 60 includes an input shaft 62, a spur gear 64, a face or crown gear 66, an output gear 68, and the output shaft 50. Generally, the torque transmission device 60 is configured to transmit an input torque about a first axis 70 into an output torque about a second axis 72 that is perpendicular to the first axis. The input torque is generated by the torque generating device 30, which rotates an output shaft 31 of the device about the first axis 70. The output torque is transmitted to a driven device 40 via the output shaft 50, which rotates about the second axis 72. In one embodiment, the torque transmission device 60 includes at least one gear that rotates about at least one additional axis for transmitting torque from the first or input axis 70 to the second or output axis 72.

Referring to FIGS. 3 and 4, the input shaft 62 of the torque transmission device 60 is co-rotatably coupled to the output shaft 31 of the torque generating device 30. Accordingly, the input shaft 62 co-rotates about the first axis 70 along with the output shaft 31. In one implementation, the input shaft 62 is separately formed relative to the output shaft 31, and attached to the output shaft 31 in a co-rotatable manner, such as via splined engagement. In another implementation, the input shaft 62 and output shaft 31 are integrally formed as a one-piece monolithic construction.

The input shaft 62 includes the spur gear 64 at a distal end of the input shaft. The spur gear 64 is coupled to the input shaft 62 and co-rotates with the input shaft about the first axis 70. The spur gear 64 can be separately formed relative to the input shaft 62, or integrally formed as a one-piece monolithic construction with the input shaft. The spur gear 64 includes a plurality of teeth 65 spaced at regular intervals about the first axis 70. The teeth 65 of the spur gear 64 project radially outwardly away from the first axis 70 of the input shaft 62. Each tooth 65 extends longitudinally in a direction parallel to the first axis 70 such that the teeth 65 are aligned with the first axis 70. The input shaft 62 and spur gear 64 can be rotatably supported within the inner cavity 48 of the housing body 46 using any of various techniques, such as through the use of one or more bearings. The size, shape, and number of the teeth 65 correspond with the configuration of the teeth 67 of the face gear 66 as will be explained in more detail below. The teeth 65 of the spur gear 64 externally contact the teeth of the face gear 66 to rotate the face gear.

The face gear 66 rotates about the third axis when driven by, or when driving, the spur gear 64. The face gear 66 includes a disk-like portion 87 coupled to a central shaft portion 89. Both the disk-like portion 87 and central shaft portion 89 are concentric with and rotate about the third axis 74. The face gear 66 includes a plurality of teeth 67 extending transversely from a face of the disk-like portion 87. The teeth 67 are circumferentially spaced at regular intervals on the face of the disk-like portion 87 about the third axis 74. Accordingly, unlike the teeth 65 of the spur gear 64, which are located on the circumferential outer periphery of the spur gear, the teeth 67 of the face gear 66 are on the face of the face gear adjacent the outer periphery of the face gear. Moreover, in contrast to the spur gear 64, each tooth 67 of the face gear 64 extends longitudinally in a direction perpendicular to the third axis 74 and has edges defining the flanks of the teeth that run parallel to a radius of the face gear 66.

The so-called pressure angle of the teeth 67 of the face gear 66 increases in a radially outward. At some radial location along teeth, the pressure angle of the teeth 67 is the same as pressure angle of the spur gear teeth 64. At other radial locations long the teeth 67, the pressure angle of the teeth 67 are similar enough to the spur gear teeth 64 to provide proper meshing engagement with the spur gear teeth. The face gear 66 is rotatably supported in the inner cavity 48 of the actuator body 46 by one or more bearings 91, 93. As the input shaft 62 rotates about the first axis 70, the spur gear teeth 65 mesh with the face gear teeth 67 to redirect the applied torque from rotation about the first axis 70, to rotation about the third axis 74.

The central shaft portion 91 of the face gear 66 includes a straight cut gear section 69 or spline near a distal end of the central shaft portion. The disk-like portion 87 can be separately formed and coupled to the central shaft portion 91, or integrally formed as a one-piece monolithic construction with the central shaft portion. Regardless, the central shaft portion 91 is co-rotatably coupled to the disk-like portion 87 such that the central shaft portion rotates about the third axis 74 as the disk-like portion 87 rotates about the third axis. The pressure angle of the teeth of the straight cut gear section 69 corresponds to the pressure angle of the teeth 95 of the output gear 68 with which the straight cut gear section 69 is enmeshed.

The output gear 68 rotates about the second axis 72 and is coupled to the output shaft 50 at the distal end of the output gear 68. The output gear 68 can be separately formed relative to the output shaft 50, or integrally formed as a one-piece monolithic construction with the output shaft. The output gear 68 includes a plurality of teeth 97 spaced at regular intervals that project radially outwardly about the second axis 72. Each tooth is longitudinally straight and aligned parallel to the second axis 72. The output gear teeth 97 are meshed with the straight cut gear section teeth 95. The output gear 68 is rotatably supported in the inner cavity 48 of the actuator body 46 by one or more bearings. When the face gear 66 rotates about the third axis 74, the corresponding torque is transmitted from rotation about the third axis 74 to the output gear 68 for rotation about the second axis 72 via the gear meshing engagement between the teeth 95 of the face gear 66 and the teeth 97 of the output gear.

Based on the foregoing, the actuator assembly 10 has a direct coupling between the input shaft 62 and the spur gear 64, a direct gear meshing engagement between the spur gear 64 and the face gear 66, a direct gear meshing engagement between the face gear 66 and the output gear 68, and a direct coupling between the output gear 68 and the output shaft 50. Such a configuration facilitates the backdrivability of the input shaft 62 by the output shaft 50 in certain applications.

In one embodiment the torque multiplication ratio between the input shaft 84 and output shaft 50 may at most be about 50:1. Additionally, in some implementations, the torque generating device 20 preferably generates at most about 15 Newton meters (N-m).

Referring to FIG. 4, and according to another embodiment of the actuator assembly 10, a circuit board 82, such as a printed circuit board (PCB), is mounted in the interior cavity 48 of the actuator body 46 of the actuator assembly 10. The PCB 82 is integrated into the torque transmission device 60 and also connected to an electrical back-shell connector 80 through wires which carry power and electrical signals. The PCB 82 includes inputs that receive the power and control wires 83 of the torque transmission device 60. The PCT 82 includes control circuitry configured to electrically control actuation of the torque generating device 30. Accordingly, many types of torque transmission devices 60 can be mechanically coupled to the input interface 22 and electrically coupled to the PCB 82. In this manner, the housing 20 of the assembly 10 is completely self-contained and does not require the torque transmission device 60 to have extraneous control elements for operation.

The electrical back-shell connector 80 is attached to the back of the actuator body 46 and connected to circuitry of the PCB 82 that is internal to the actuator housing 20. The electrical back-shell connector 80 can be of a universal or standardized type that will easily receive external universally matable electrical connectors, which can be electrically coupled to a central control unit or electronic control module. The connector 80 can be made of a single piece of multiple separately couplable pieces. Further, the connector 80 may have a locking structure formed about the connector 80. The locking structure may provide low insertion and high withdrawal forces to an external electrical connector inserted in the connector 80. Both the electrical connector 80 and the mating connector may have keying components which permit the connectors to be joined in only one orientation, preventing errors in power and signal transmission.

Positioning the PCB 82 for controlling operation of the torque generating device 30 within the housing 20, and providing a universally accepted electrical connector 80, allows the torque generating device 30, to be quite versatile and not require a separate circuit board. Thus, many commercially off the shelf devices without control circuitry may be connected to the actuator assembly and controlled directly from the actuator's internal PCB 82. This provides greater flexibility when selecting among which torque generating devices 30 to select for an application. It also allows for rapid interchangeability when converting from one type of torque generating device 30 to another.

In the above description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

Those skilled in the art will recognize that the present subject matter may be embodied in other specific forms by modifications, substitutions and changes without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An actuator assembly, comprising:
a housing comprising an input interface and an output interface;
a torque generating device coupled to an input shaft, the torque generating device being coupled to the input interface of the housing such that the input shaft is positioned within the housing;
a spur gear coupled to the input shaft;
a face gear positioned within the housing, the face gear being in gear meshing engagement with the spur gear; and
an output shaft coupled to the face gear and extending from the output interface, the output shaft being approximately perpendicular to the input shaft.

2. The actuator assembly of claim 1, wherein the torque generating device rotationally drives the input shaft and spur gear.

3. The actuator assembly of claim 2, wherein the torque generating device is selected from the group consisting of an electromagnetic motor and pneumatic drive.

4. The actuator assembly of claim 1, further comprising an output device coupled to the output interface, the output device being rotationally coupled to the output shaft.

5. The actuator assembly of claim 1, wherein the output interface comprises a pilot feature.

6. The actuator assembly of claim 1, wherein the output interface comprises four mounting apertures that are circumferentially spaced about the output shaft an equal distance apart from each other.

7. The actuator assembly of claim 1, wherein the gear meshing engagement between the face gear and spur gear allows backdrivability of the input shaft by the output shaft.

8. The actuator assembly of claim 1, further comprising a printed circuit board (PCB) mounted within the housing and electrically coupled to the torque generating device, the PCB being configured to electrically control actuation of the torque generating device.

9. The actuator assembly of claim 8, wherein the PCB is electrically coupled to the torque generating device via a universal connector forming an integral part of the housing.

10. The actuator assembly of claim 1, wherein a torque multiplication ratio between the input and output shafts is at most about 50:1.

11. The actuator assembly of claim 1, wherein the torque generating device generates at most about 15 Newton meters (N-m).

12. An internal combustion engine, comprising:
an actuator assembly comprising a housing with an input interface and an output interface;
a torque generating device coupled to an input shaft, the torque generating device being coupled to the input interface of the housing such that the input shaft is positioned within the housing;
a spur gear coupled to the input shaft;
a face gear positioned within the housing, the face gear being in gear meshing engagement with the spur gear;
an output shaft coupled to the face gear and extending from the output interface, the output shaft being approximately perpendicular to the input shaft; and
an actuatable device mounted to the output interface and coupled to the output shaft.

13. The internal combustion engine of claim 10, wherein the actuator assembly device further comprises a printed circuit board (PCB) mounted to the housing, the PCB being configured to electronically control actuation of the torque generating device.

14. The internal combustion engine of claim 10, wherein the actuator assembly has four mounting apertures circumferentially spaced about the output shaft an equal distance apart from each other.

15. The internal combustion engine of claim 10, wherein the gear meshing engagement between the face gear and spur gear that allows backdrivability of the input shaft by the output shaft.

16. An actuator, comprising:
a housing;
a spur gear positioned within the housing, the spur gear being rotatable about a first rotational axis;
an input shaft coupled with the spur gear;
a face gear positioned within the housing in gear meshing engagement with the spur gear, the face gear being rotatable about a second rotational axis that is perpendicular to the first rotational axis; and
an output shaft coupled with the face gear.

17. The actuator of claim 16, further comprising a printed circuit board (PCB) and universal connector mounted to the housing, the PCB being in electrically coupled with the universal connector, wherein the PCB is configured to electronically control actuation of the spur gear about the first rotational axis

18. The actuator of claim 16, wherein gear meshing engagement between the face gear and spur gear allows backdrivability of the spur gear by the face gear.

19. The actuator of claim 16, wherein the housing comprises a pilot feature about the output shaft, the pilot feature being mateable with an accessory positioned between the housing and a device driven by the output shaft.

20. The actuator of claim 19, wherein the housing comprises a plurality of mounting apertures circumferentially spaced about the pilot feature, the mounting apertures being mateable with corresponding mounting features of the device driven by the output shaft.
